(19) United States
(12) Patent Application Publication
(10) Pub. No.: US 2008/0077606 A1
(43) Pub. Date: Mar. 27, 2008

(54) METHOD AND APPARATUS FOR FACILITATING EFFICIENT PROCESSING OF EXTENSIBLE MARKUP LANGUAGE DOCUMENTS

(75) Inventors: Jianjun Fang, Long Grove, IL (US); Bhavan R. Gandhi, Vernon Hills, IL (US); Faisal Ishtiaq, Chicago, IL (US); Alfonso Martinez Smith, Algonquin, IL (US); Wei Wang, Barrington, IL (US)

Correspondence Address: MOTOROLA, INC., 1303 EAST ALGONQUIN ROAD, IL01/3RD, SCHAUMBURG, IL, 60196, US

(73) Assignee: MOTOROLA, INC., Schaumburg, IL (US)

(21) Appl. No.: 11/535,235

(22) Filed: Sep. 26, 2006

(51) Int. Cl. G06F 7/00

(52) U.S. Cl. 707/101

(57) ABSTRACT

Both an XML schema and XML instance data as correspond to an XML document are provided (301). The XML schema is processed (302) apart from the XML instance data to provide resultant compressed XML schema data while the XML instance data is processed (303) to provide a corresponding XML instance table. The latter is compressed (304) to yield a resultant compressed XML instance table. Following receipt of such items, the compressed XML instance table is decompressed (403) to provide a resultant XML instance table with the latter being used (404), along with the XML schema, to facilitate a corresponding XML document process.

### TECHNICAL FIELD

This invention relates generally to XML (eXtensible Markup Language) documents and more particularly to methods of processing the data and schema within those documents.

### BACKGROUND

XML documents are generally used for a wide variety of purposes, including, by way of examples, for databases, for electronic commerce, for Java based Internet programming, for Website development, and for multimedia. More particularly, XML documents are the preferred structured data document used when communicating data to wireless enabled mobile devices, such as cell phones or Personal Digital Assistants (PDAs). A common feature of XML documents is the use of an associated schema document to describe the structure, content, and/or semantics of XML instance documents. An XML schema defines the legal building blocks of an XML instance document such as the elements or attributes that can appear in the instance document, relationships between the elements of the instance document, the data types of elements and attributes, and default values for elements and attributes. XML schemas are typically written in XML and support data types and namespaces. An XML schema can be reused in other schemas. It is also possible to reference multiple XML schemas from a single document.

A common setback in regards to the processing of XML instance documents is the inefficient transfer of XML data from senders to recipients, for example between a sender and a recipient mobile device, and the time intensive processing required by the recipient. XML schema documents and their associated XML instance documents are typically defined in plain text format and thus provide a generally software- and hardware-independent way of communicating data. The use of plain text format, however, typically means that XML instance documents and their related schema require significant memory and bandwidth for transmission. Additionally, because schema elements are only syntactically organized, the entire schema generally must be parsed before any part of the schema can be used, requiring significant processing time and power on the receiving end.

In response to these issues, it is known that there exist a variety of compression/decompression and processing techniques on the sender and recipient side. These techniques effectively reduce the physical size of the XML instance documents and associated schema, which subsequently allow for faster transmission from sender to recipient. Furthermore, there exist methods for reducing the time a sender or recipient machine needs to process XML documents. Although these proposals have improved the processing and transmission of XML schema and instance documents, there is still significant room for improvement.

### BRIEF DESCRIPTION OF THE DRAWINGS

The above needs are at least partially met through provision of the method and apparatus for facilitating efficient processing of XML documents described in the following detailed description, particularly when studied in conjunction with the drawings, wherein:

FIG. 1 comprises a representation of the structure of an XML instance document as configured in accordance with various embodiments of the invention;

FIG. 2 comprises another representation of the structure of an XML instance document as configured in accordance with various embodiments of the invention;

FIG. 3 comprises a schematic diagram of a method for processing an XML instance document and associated schema as configured in accordance with various embodiments of the invention;

FIG. 4 comprises a schematic diagram of a method for processing a compressed XML instance table and associated schema on recipient device as configured in accordance with various embodiments of the invention;

FIG. 5 comprises a schematic diagram representing an example of an XML schema document as configured in accordance with various embodiments of the invention;

FIG. 6 comprises a schematic diagram of another representation of an example of an XML schema document as configured in accordance with various embodiments of the invention;

FIG. 7 comprises a schematic diagram of an apparatus for processing an XML instance document and associated schema as configured in accordance with various embodiments of the invention;

FIG. 8 comprises a schematic diagram of a compressed XML instance table as configured in accordance with various embodiments of the invention;

FIG. 9 comprises a schematic diagram of a example data represented in the XML instance table described in FIG. 8, as configured in accordance with various embodiments of the invention; and

FIG. 10 comprises a schematic view of an end-to-end flow as configured in accordance with various embodiments of the invention.

Skilled artisans will appreciate that elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. It will further be appreciated that certain actions and/or steps may be described or depicted in a particular order of occurrence while those skilled in the art will understand that such specificity with respect to sequence is not actually required. It will also be understood that the terms and expressions used herein have the ordinary meaning as is accorded to such terms and expressions with respect to their corresponding respective areas of inquiry and study except where specific meanings have otherwise been set forth herein.

### DETAILED DESCRIPTION

A compressed XML instance table wherein the XML instance data is made separate from the XML schema and a related method are provided. The instance table and related method provide substantial savings with respect to processing the XML instance document on the sender, sending the compressed XML instance table from the sender to recipient, and processing the compressed XML instance table on the recipient.

At least one significant advantage of the compressed XML instance table can arise when the verbose schema information is presented by a single numerical number (i.e., a node code). This can yield a substantial resultant savings in compression and decompression processing. Since the schema information is no longer a part of the compressed bitstream and can be obtained separately at the recipient, a higher efficient compression and decompression algorithm can be achieved.

By one approach, the XML instance table comprises at least one node that represents actual XML value information. By this approach, each node can also be associated with corresponding instance path information.

Another advantage of the disclosed compressed XML instance table is the ability to use different compression algorithms for a node's instance path information, which is represented by integer-based codes, and the node's value information, which is represented by text-based values. There are available algorithms, for example, that are distinctly better at compressing and decompressing integer-based codes as opposed to text-based values, and vice-versa. Separating the integer-based codes from the text-based values enable one to effectively utilize the most efficient algorithm for a particular component of the XML instance table.

Another advantage of the disclosed compressed XML instance table is the incorporation of an error detector within the table de-compressor. Since the XML instance table is encoded into isolated groups, this error detector can detect data corruption within one group and signal to the sender for re-transmission without having to retransmit the other isolated groups within the binary instance table.

As yet another benefit, the introduction and use of both an XML schema information table and an XML instance table can facilitate metadata retrieval in an SQL-type of database application setting.

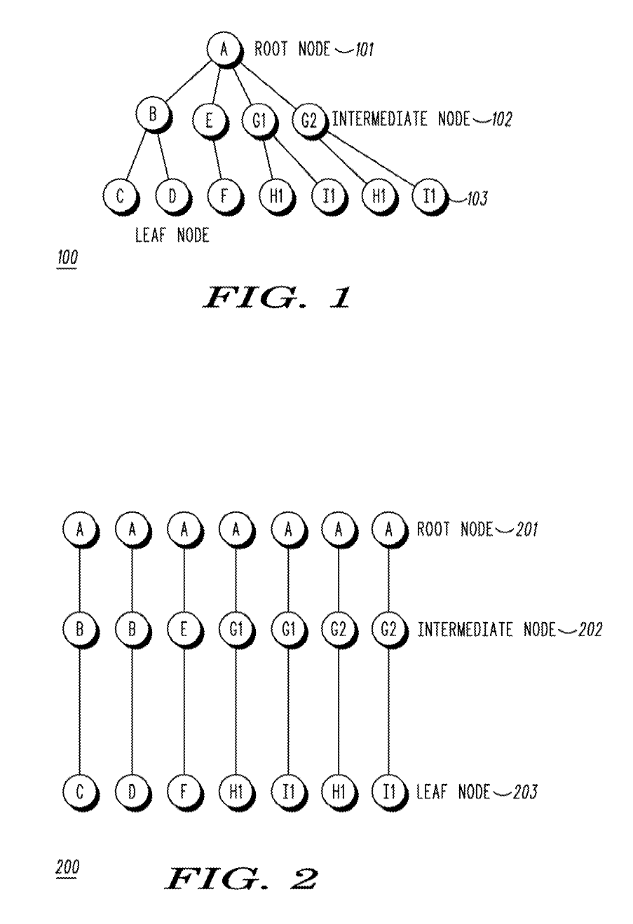

These and other benefits may become clearer upon making a thorough review and study of the following detailed description. Referring now to the drawings, and in particular to FIG. 1, the XML instance document as specified by its associated schema is represented in structural form 100, where the root node 101 defines the starting point of representing the location of at least one leaf node 103. The structural path from the root node 101 to any leaf node 103 may pass through any number of intermediate nodes 102, depending on the complexity of the XML instance document and associated schema.

FIG. 2 is an illustrative embodiment in this regard and represents the paths 200 to each leaf node 203 represented in FIG. 1. The full path to each leaf node 203 is represented by a root node 201, possibly one or several intermediate nodes 202, and finally the leaf node 203. This figure shows how each leaf node's instance path information can be represented.

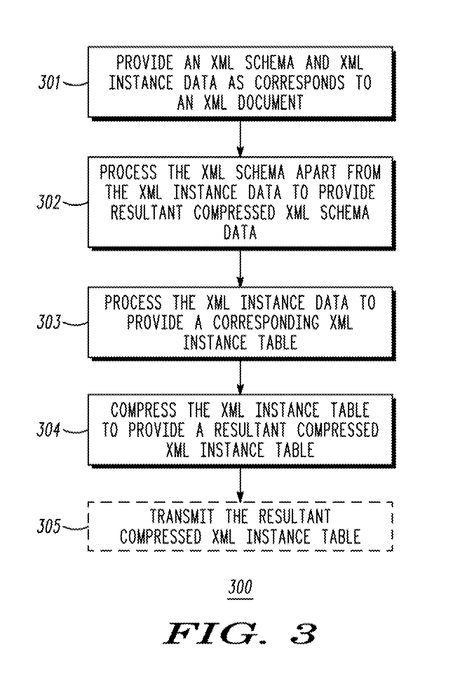

Those skilled in the art will appreciate that the above-described structures are readily processed using any of a wide variety of available and/or readily configured processes, including partially or wholly programmable processes as are known in the art or dedicated purpose platforms as may be desired for some applications. Referring now to FIG. 3, an illustrative approach to such a process will now be provided.

FIG. 3 describes a method 300 that provides for provision 301 of an XML instance data and an associated schema and that will process 302 the XML schema apart from the XML instance data to provide a resultant compressed XML schema data. The method 300 will also process 303 the XML instance data to provide a corresponding XML instance table. The XML instance table will then be compressed 304 to provide a resultant compressed XML instance table. An illustrative example of the format of an XML instance table is shown in Table 1 below. The order of these operations 302, 303, and 304 is not significant. For many application settings, however, it may be useful that the compression operation 304 be performed after the provision of the corresponding XML instance table operation 303.

TABLE 1
Example of format of an XML instance table

| NodeCode | InstancePath | Value |
|---|---|---|
| . . . | . . . | . . . |

In one embodiment of this invention, the corresponding XML instance table comprises at least one node code with corresponding node instance path information and node value information. In the case where there is a plurality of node codes, each node code can be differentially coded prior to being compressed if so desired. Such node codes serve, at least in part, to make an association with a corresponding XML schema information table and permit a relatively effective degree of XML instance table compression to be attained when employed as described. Those skilled in the art will further appreciate that such node codes can be readily independently regenerated if necessary when the XML schema itself is available (for example, as may be obtained from binary schema information as discussed herein).

It can be desirable in some circumstances, before compressing 304 the XML instance table, to separate the XML instance data into two distinct parts: node instance path information and node value information. The node instance path information can be generated, in part, by the associated XML schema in the form of node code in order to ensure that the XML instance data is separated from the XML schema. Each part of the XML instance data, the node instance path information, and the node value information can then be compressed using a different compression technique, with the technique for compressing the node instance path information being different than the technique for compressing the node value information. It may be desirable to select the corresponding compression techniques from a plurality of compression techniques, which take into account, at least in part, the quantity of information to be compressed.

It may also desirable in some circumstances to partition the XML instance table into groups and to relay error check information regarding those groups. The advantage in this embodiment is that each group can be independently verified using a checksum procedure, and if a group is found to be corrupt then only that group will need to be re-processed or re-transmitted, as opposed to re-processing or re-transmitting the entire XML instance table.

It can be desirable in some circumstances, for example in mobile environments, to transmit the compressed XML instance table 305. The reduction in size due to the compression techniques described in this method 300 provides efficiencies in bandwidth usage and in processing time performance by the recipient. Furthermore, it may be desirable to also transmit an identification of the corresponding XML schema information. This would be advantageous, in particular, in mobile environments where the receiving mobile device may not know of the XML instance table's associated schema information, but where the mobile device has access to the schema. Furthermore, transmitting schema identification rather than the entire schema results in less data to transfer from sender to recipient, resulting in an increased efficiency of network bandwidth use.

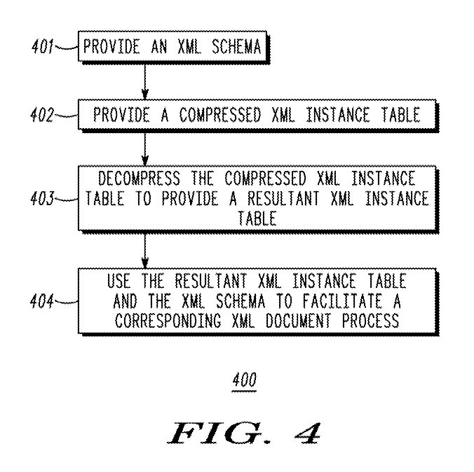

Referring now to FIG. 4, further details regarding a process 400 of processing a compressed XML instance table and associated schema will be provided. This process 400 provides for provision 401 of an XML schema as well as provision 402 of a compressed XML instance table. The compressed XML instance table is decompressed 403 to provide a resultant XML instance table. This instance table, along with the XML schema, is then used 404 to facilitate a corresponding XML document process. By one approach, the provided XML schema may comprise a compressed XML schema, and thus it would usually be useful to decompress that information.

By another approach, the provided XML schema may be in the form of a discernable identification of the XML schema. In which case, by this approach, the method can provide for retrieving the associated XML schema information as it corresponds to the provided identification.

By yet another approach, the provided compressed XML instance table is received by any form of transmission, such as a wireless transmission of data. Furthermore, the received compressed XML instance table can be partitioned into groups and thus it is possible to receive transmission of one group independent of or in combination with any other group or groups. It can be desirable then to verify the contents of each compressed XML instance table group by any checksum procedure. Therefore, if an error in transmission of one of the groups is detected, only that group will need to be retransmitted.

An embodiment of decompressing the compressed XML instance table to provide a resultant XML instance table comprises of separately decompressing the node instance path information and the node value information. Furthermore, it may be desirable to use a decompression technique for decompressing the node value information and a separate decompression technique for decompressing the node instance path information.

An illustrative example of an XML schema information table is provided in Table 2 below.

TABLE 2
Example of an XML schema information table

| NodeCode | NodeType | NodeName | NodeClass | XPath | NodePath | Alias |
|---|---|---|---|---|---|---|
| . . . | . . . | . . . | . . . | . . . | . . . | . . . |

NodeCode - Numerical representation of a node. The node can be an element, an attribute, a type cast, or substitution, which is indicated by the field of NodeClass.
NodeType - Data type of a node specified in the XML schema
NodeName - Name of a node specified in the XML schema.
NodeClass - Category of a node, such as element, attribute, etc.
XPath - XPath of a node
NodePath - Same as XPath, except node names are replaced with node codes.
Alias - User-friendly name for query purpose.

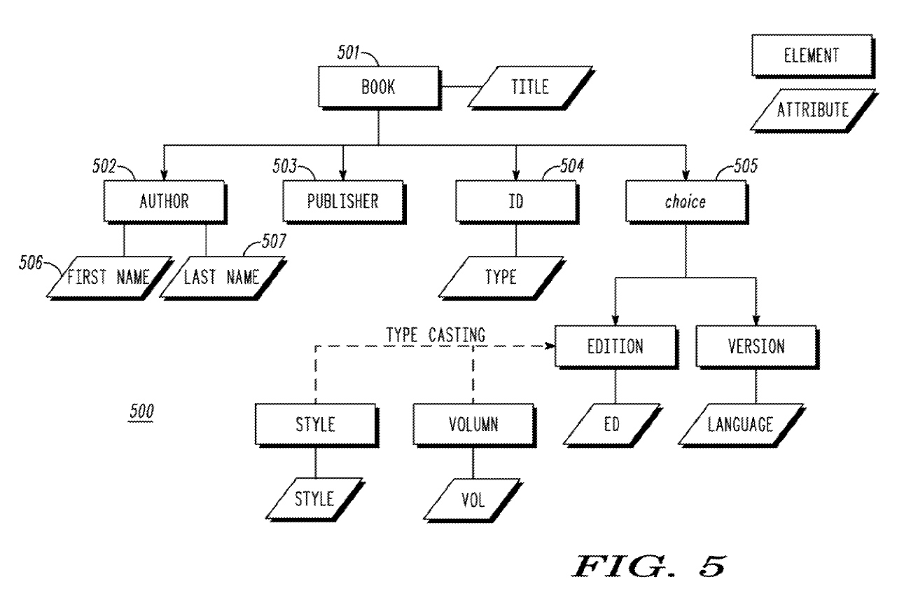

Referring now to FIG. 5, an illustrative example of an XML schema 500 depicts the legal building blocks of an XML instance document in regards to books. In this example an element book 501 has associated elements 502, 503, 504, 505 and an attribute 506. Furthermore, each element has its own attributes. For example, the attribute author 502 has two elements firstName 506 and lastName 507. Therefore, the XML instance document in relation to this schema 500 will describe a book with an author with a first and last name.

An illustrative example of XML source code for the schema associated with the example set forth in FIG. 5 is shown in Table 3 below.

TABLE 3
Example of XML source code for schema associated with
the example in FIG. 5

```
<?xml version=“1.0” encoding=“UTF-8”?>
<schema targetNamespace=“urn:tva:schema:2001” elementFormDefault=“qualified”
attributeFormDefault=“unqualified” xmlns:tva=“urn:tva:schema:2001”
xmlns=“http://www.w3.org/2001/XMLSchema”>
  <element name=“book”>
    <complexType name=“bookType”>
      <sequence>
        <element name=“author” type=“tva:authorType” maxOccurs=“unbounded”/>
        <element name=“publisher” type=“string” minOccurs=“0” maxOccurs=“unbounded”/>
        <element name=“ID” type=“tva:IdType”/>
        <choice>
          <element name=“edition” type=“tva:editionType”/>
          <element name=“version” type=“tva:versionType”/>
        </choice>
      </sequence>
      <attribute name=“title” type=“string”/>
    </complexType>
  </element>
  <complexType name=“authorType”>
    <attribute name=“firstName” type=“string”/>
    <attribute name=“lastName” type=“string”/>
  </complexType>
  <complexType name=“IdType”>
    <simpleContent>
      <extension base=“string”>
        <attribute name=“type” type=“string”/>
      </extension>
    </simpleContent>
  </complexType>
  <complexType name=“editionType”>
    <attribute name=“ed” type=“string”/>
  </complexType>
  <complexType name=“volumnType”>
    <complexContent>
      <extension base=“tva:editionType”>
        <attribute name=“vol” type=“string”/>
      </extension>
    </complexContent>
  </complexType>
  <complexType name=“styleType”>
    <complexContent>
      <extension base=“tva:editionType”>
        <attribute name=“style” type=“string”/>
      </extension>
    </complexContent>
  </complexType>
  <complexType name=“versionType”>
    <attribute name=“language” type=“string”/>
  </complexType>
</schema>
```

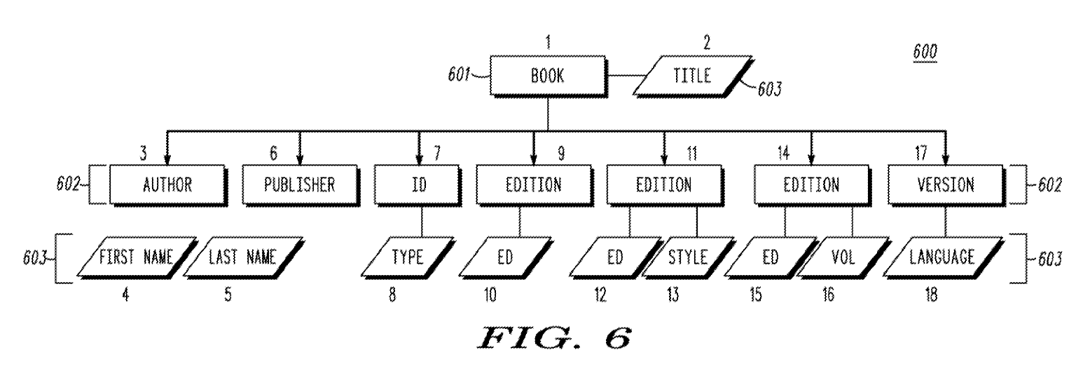

FIG. 6 represents an extended view of FIG. 5's XML schema 500. This representation 600 can facilitate generating node codes for this example schema. Whereas in FIG. 5 the representation of the schema has several tiers of elements, this representation has only two levels of elements, the root book node 601 and several elements 602. Each of these elements may or may not have associated attributes 603. Based on this representation 600, the schema information table is ready to be constructed.

An illustrative example of the Schema Information Table associated with the example described in FIG. 6 is shown in Table 4 below. Those skilled in the art will note the inclusion in this Table of an attribute labeled “Alias.” This attribute can serve to permit content providers to define user-friendly aliases for a selected group of nodes in the Schema Information Table to thereby facilitate information retrieval from the associated database. Metadata providers can choose to leave this attribute empty for other nodes if desired.

TABLE 4
Example of the Schema Information Table based on the
example described in FIG. 6

| NodeCode | NodeType | NodeName | NodeClass | XPath | NodePath | Alias |
|---|---|---|---|---|---|---|
| 1 | bookType | Book | element | /bookType | [1] | — |
| 2 | String | Title | attribute | /bookType/title | [1, 2] | Title |
| 3 | authorType | author | element | /bookType/authorType | [1, 3] | — |
| 4 | String | firstName | attribute | /bookType/authorType/firstName | [1, 3, 4] | First Name |
| 5 | String | lastName | attribute | /bookType/authorType/lastName | [1, 3, 5] | Last Name |
| 6 | String | publisher | element | /bookType/publisher | [1, 6] | Publisher |
| 7 | String | ID | element | /bookType/ID | [1, 7] | ID |
| 8 | String | Type | attribute | /bookType/IdType/type | [1, 7, 8] | ID type |
| 9 | editionType | edition | element | /bookType/editionType | [1, 9] | — |
| 10 | String | Ed | attribute | /bookType/editionType/ed | [1, 9, 10] | — |
| 11 | styleType | edition | typeCast | /bookType/styleType | [1, 11] | Edition |
| 12 | String | Ed | attribute | /bookType/styleType/ed | [1, 11, 12] | — |
| 13 | String | Style | attribute | /bookType/styleType/style | [1, 11, 13] | Style |
| 14 | volumnType | edition | typeCast | /bookType/volumnType | [1, 14] | — |
| 15 | String | Ed | attribute | /bookType/volumnType/ed | [1, 14, 15] | — |
| 16 | String | Vol | attribute | /bookType/volumnType/vol | [1, 14, 16] | Volume |
| 17 | versionType | version | element | /bookType/versionType | [1, 17] | Version |
| 18 | String | language | attribute | /bookType/versionType/language | [1, 17, 18] | Language |

The following Table 5 is an illustrative example of an XML instance document associated with the XML schema described in Table 3.

TABLE 5
Example of an XML instance document associated with the
XML schema described in Table 3

```
<?xml version=“1.0” encoding=“UTF-8”?>
<book xmlns=“urn:tva:schema:2001”
xmlns:xsi=http://www.w3.org/2001/XMLSchema-instance
    xsi:schemaLocation=“urn:tva:schema:2001
    H:♯DVB♯Encoding♯testSchema2.xsd” title=“MPEG-7 BiM”>
  <author firstName=“John” lastName=“Duo”/>
  <author firstName=“Jane” lastName=“Duo”/>
  <publisher>Random House</publisher>
  <ID type=“ISBN”>123-456-7890</ID>
  <edition ed=“1” xsi:type=“styleType” style=“hardcover”/>
</book>
```

The following Table 6 is an illustrative example of the full version of an XML instance table possibly used for insertion into a database, based on the XML instance document described in Table 5.

Table 6. Full version of XML instance table based on XML instance document described in Table 5

TABLE 6
Instance Table (the full version for the database)

| NodeCode | InstancePath | Value |
|---|---|---|
| 2 | /1#1/2#1 | MPEG-7 BiM |
| 4 | /1#1/3#1/4#1 | John |
| 4 | /1#1/3#2/4#1 | Jane |
| 5 | /1#1/3#1/5#1 | Duo |
| 5 | /1#1/3#2/5#1 | Duo |
| 6 | /1#1/6#1 | Random House |
| 7 | /1#1/7#1 | 123-456-7890 |
| 8 | /1#1/7#1/8#1 | ISBN |
| 12 | /1#1/11#1/12#1 | 1 |
| 13 | /1#1/11#1/13#1 | Hardcover |

The following Table 7 is an illustrative example of a simplified version of an XML instance table possibly used for transmission as described in Table 6.

TABLE 7
Simplified XML instance table based on XML instance
table described in Table 6

| NodeCode | InstancePath | Value |
|---|---|---|
| 2 | [1] | MPEG-7 BiM |
| 4 | [1, 1] | John |
| 4 | [1, 2] | Jane |
| 5 | [1, 1] | Duo |
| 5 | [1, 2] | Duo |
| 6 | [1, 1] | Random House |
| 7 | [1, 1] | 123-456-7890 |
| 8 | [1, 1] | ISBN |
| 12 | [1, 1] | 1 |
| 13 | [1, 1] | Hardcover |

The following Tables 8, 9, 10, and 11 are illustrative examples of the process of compressing the contents of Table 7.

TABLE 8
Example of encoding process for node codes

| | | | | Run- | Run- |
|---|---|---|---|---|---|
| | | | | length | values |
| 2 | | | | | |
| 4 | | | | 1 | 2 |
| 4 | | | | 1 | 0 |
| 5 | | | | 1 | 1 |
| 5 | | | | 1 | 0 |
| 6 | → | 2 4 4 5 5 6 7 8 12 13 | 2 2 0 1 0 1 1 1 4 1 | 3 | 1 |
| 7 | | | | 1 | 4 |
| 8 | | | | 1 | 1 |
| 12 | | | Note: the 1^{st} number | | |
| 13 | | | is initial value | | |

TABLE 9
Example of encoding process for instance paths

| | | | | | Run- |
|---|---|---|---|---|---|
| | | | | Run- | val- |
| | | | | length | ues |
| /1 | | | | | |
| /1/1 | | | | 10 | 0 |
| /1/2 | | | | 1 | 1 |
| /1/1 | | | | 1 | −1 |
| /1/2 | | | | 1 | 1 |
| /1/1 | → | 1 1 1 1 1 1 1 1 1 1 1 | 1 0 0 0 0 0 0 0 0 0 0 1 | 1 | −1 |
| /1/1 | | 2 1 2 1 1 1 1 1 | −1 1 −1 0 0 0 0 | 4 | 0 |
| /1/1 | | | | | |
| /1/1 | | | Note: the 1^{st} number is | | |
| /1/1 | | | initial value | | |

TABLE 10
Example of a compression technique by calculating the
Huffman codeword of the run-lengths and the run-values generated
in Tables 8 and 9

| Run- | | Huffman | Run- | | |
|---|---|---|---|---|---|
| length | Frequency | code | values | Frequency | Huffman code |
| 1 | 10 | 1 | −1 | 2 | 110 |
| 3 | 1 | 00 | 0 | 4 | 10 |
| 4 | 1 | 010 | 1 | 5 | 0 |
| 10 | 1 | 011 | 2 | 1 | 1111 |
| | | | 4 | 1 | 1110 |

TABLE 11
Example of combining all values into a single long string
for Gzip compression

| | | |
|---|---|---|
| MPEG-7 | | |
| BiM | | |
| John | | |
| Jane | | |
| Duo | | |
| Duo | → | MPEG-7 BiM\0John\0Jane\0Duo\0Duo\0Random House\ |
| Random | | 0123-456-7890\0ISBN\01\0hardcover\0 |
| House | | |
| 123-456- | | |
| 7890 | | |
| ISBN | | |
| 1 | | |
| Hardcover | | |

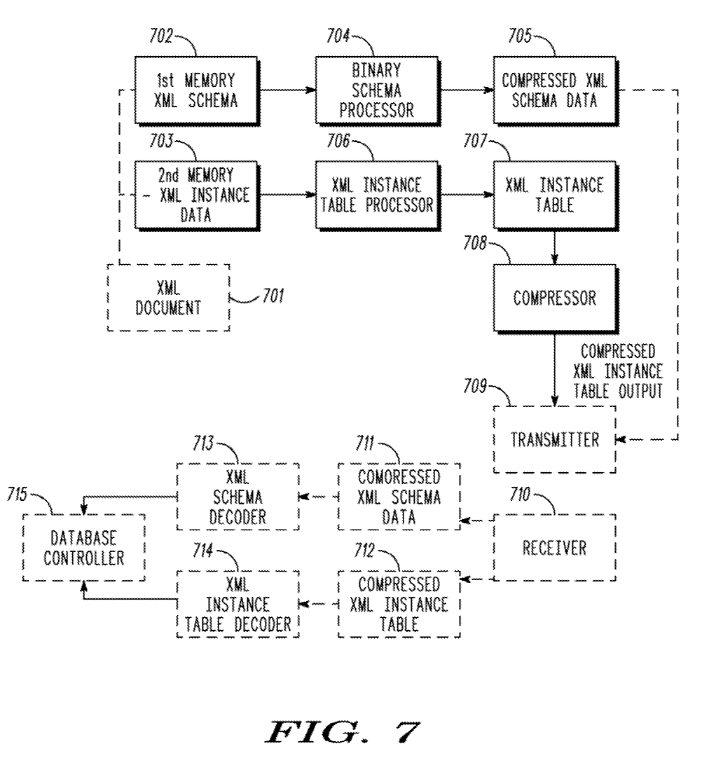

FIG. 7 depicts an apparatus 700 in which an XML document and its associated parts, instance data, and schema are compressed, then decompressed in a form where the original XML document can be recreated. An XML document 701 comprises of an XML schema 702 and XML instance data 703, which can be stored in different memory locations. The XML schema is processed by a Binary Schema Processor 704, which provides a compressed XML schema 705. Correspondingly, the XML instance data is processed by an XML instance table processor 706, which results in an XML instance table 707. This instance table is processed by a compressor 708, which results in a compressed XML instance table. Both the compressed XML schema data 705 and the resultant compressed XML instance table from the compressor 708 can be transmitted by a transmitter 709 to a recipient, which can receive such data 710. The recipient then applies the compressed XML schema data 711 and compressed XML instance table 712 to an XML schema decoder 713 and an XML instance table decoder 714, respectively. The resultant XML schema and XML instance table can be used to formulate an instantiation of the XML document 701. Optionally, if desired, this apparatus 700 can further comprise a database controller 715 that operably couples to the XML schema decoder 713 and the XML instance table decoder 714. So configured, the database controller 715 can serve, at least in part, to populate the information from these two sources into a corresponding database (to facilitate usage and/or later usage of such information).

Those skilled in the art will recognize and understand that such an apparatus 700 may be comprised of a plurality of physically distinct elements as is suggested by the illustration shown in FIG. 7. It is also possible, however, to view this illustration as comprising a logical view, in which case one or more of these elements can be enabled and realized via a shared platform. It will also be understood that such a shared platform may comprise a wholly or at least partially programmable platform as are known in the art.

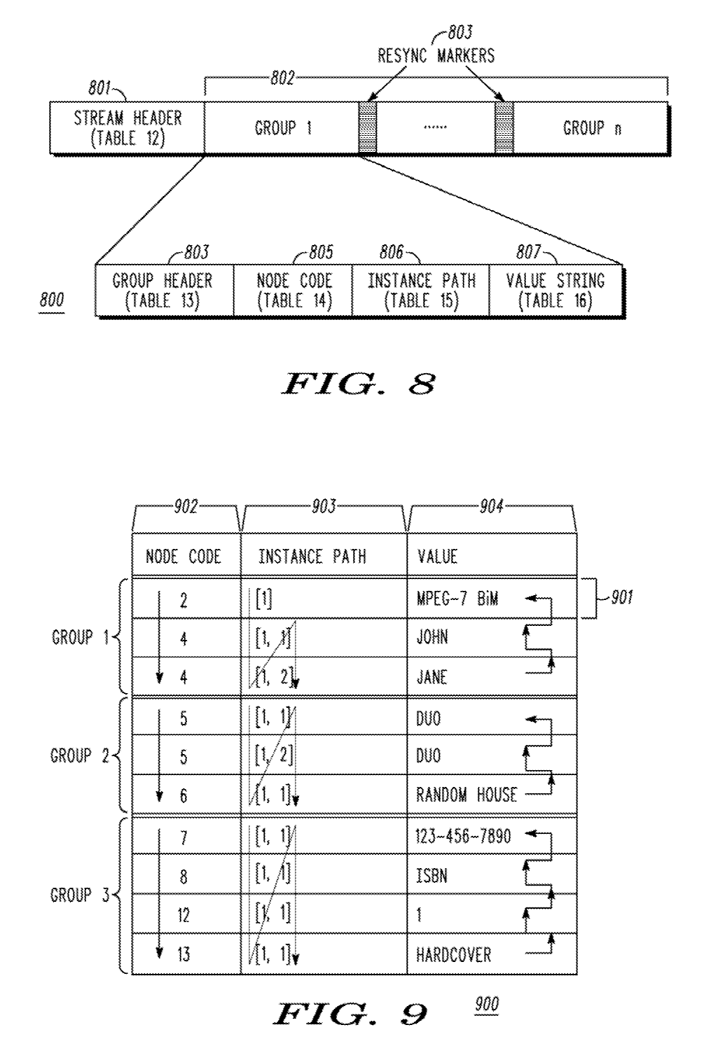

FIG. 8 presents a graphical representation 800 of a compressed instance table that is separated into a Stream Header 801 and various groups 802. The set of groups 802 of an instance table is led by a Stream Header group 801 that contains information regarding the number of groups in the instance table. Furthermore, each group is separated by Resync Markers 803. Each group aside from the Stream Header group 801 contains a Group Header 804, which contains the important parameters of each group, a Node Code 805, an Instance Path 806, and a Value String 807.

The following Table 12 is an illustrative example of the binary definition of Stream Header 801 as defined in FIG. 8.

TABLE 12
Binary definition of Stream Header

| | |
|---|---|
| CRC16 | 16 bits |
| total_bitstream_size | vluimsbf5 |
| number_of_groups | vluimsbf5 |
| encoding_mode | 6 bits |
| error_resiliency_mode | 2 bit |
| fast_decoding_flag | 1 bit |
| Huffman_table_flag | 1 bit |
| if (Huffman table flag == 1) { | |
| // *** Huffman table for run-length *** | |
| table_size | vluimsbf5 |
| number_of_Huffman_table_entries | vluimsbf5 |
| length_of_Huffman codeword 1 | vluimsbf5 |
| value_of_symbol 1 | vluimsbf5 |
| Huffman_codeword 1 | variable |
| ... ... | ... |
| ... ... | ... |
| length_of_Huffman_codeword k | vluimsbf5 |
| value_of_symbol k | vluimsbf5 |
| Huffman_codeword k | variable |
| // *** Huffman table for run-value *** | |
| table_size | vluimsbf5 |
| number_of_Huffman_table_entries | vluimsbf5 |
| length_of_Huffman_codeword 1 | vluimsbf5 |
| value_of_symbol 1 | vluimsbf5 |
| Huffman codeword 1 | variable |
| ... ... | ... |
| ... ... | ... |
| length_of_Huffman_codeword k | vluimsbf5 |
| value_of_symbol k | vluimsbf5 |
| Huffman_codeword k | variable |
| } | |

The following Table 13 is an illustrative example of the binary definition of Group Header 804 as defined in FIG. 8.

TABLE 13
Binary definition of group header

| | |
|---|---|
| if (error_resiliency_mode == 01 or 11 ) | |
| CRC16 | 16 bits |
| } | |
| group_size | vluimsbf5 |
| group_{—} index | vluimsbf5 |
| if (fast_decoding_flag) { | |
| instance_path offset | vluimsbf5 |
| value_string_offset | vluimsbf5 |
| } | |
| number_of_table_entries | vluimsbf5 |
| number_of_instance_indexes | vluimsbf5 |

The following Table 14 is an illustrative example of the binary definition of the run-length coding process shown in Table 10 for Node Code 805 as defined in FIG. 8.

TABLE 14
Binary definition of run-length coding for node codes

| | |
|---|---|
| if (mode==RUN_LENGTH) { | |
| // **** run-length coding **** | |
| run length 1 | vluimsbf5 |
| run value 1 | vluimsbf5 |
| ... ... | ... |
| ... ... | ... |
| run length k | vluimsbf5 |
| run value k | vluimsbf5 |
| padding bits | 0–7 bits |
| } else { | |
| // **** Huffman coding **** | |
| initial value | vluimsbf5 |
| Huffman code of run length 1 | variable |
| Huffman code of run value 1 | variable |
| ... ... | ... |
| ... ... | ... |
| Huffman code of run length k | variable |
| Huffman code of run value k | variable |
| padding bits | 0–7 bits |
| } | |

The following Table 15 is an illustrative example of the binary definition of the run-length coding process shown in Table 10 for Instance Path 806 as defined in FIG. 8.

TABLE 15
Binary definition of run-length coding for Instance Paths
806

| | |
|---|---|
| if (mode==RUN_LENGTH) { | |
| // **** run-length coding **** | |
| initial value | vluimsbf5 |
| run length 1 | vluimsbf5 |
| run value 1 | vluimsbf5 |
| ... ... | ... |
| ... ... | ... |
| run length k | vluimsbf5 |
| run value k | vluimsbf5 |
| padding bits | 0–7 bits |
| } else { | |
| // **** Huffman coding **** | |
| initial value | vluimsbf5 |
| Huffman code of run length 1 | vluimsbf5 |
| Huffman code of run value 1 | vluimsbf5 |
| ... ... | ... |
| ... ... | ... |
| Huffman code of run length k | vluimsbf5 |
| Huffman code of run value k | vluimsbf5 |
| padding bits | 0–7 bits |
| } | |

The following Table 16 is an illustrative example of the binary definition of the Value String 807 as defined in FIG. 8.

TABLE 16
Binary definition of the value bitstream

| | |
|---|---|
| if (mode == UTF8) { | |
| cascaded_string | array of UTF-8 |
| padding bits | 0–7 bits |
| } else { | |
| Gzip_of_cascaded_string | |
| padding bits | bytes |
| } | 0–7 bits |

FIG. 9 presents a representation 900 of groups 802 as shown in FIG. 8. Each group contains several nodes, represented as rows in the table of FIG. 9, which are subsequently defined by a NodeCode 902, an InstancePath 903, and a Value 904. The NodeCode 902 and InstancePath 903 together provide a unique identification of each node.

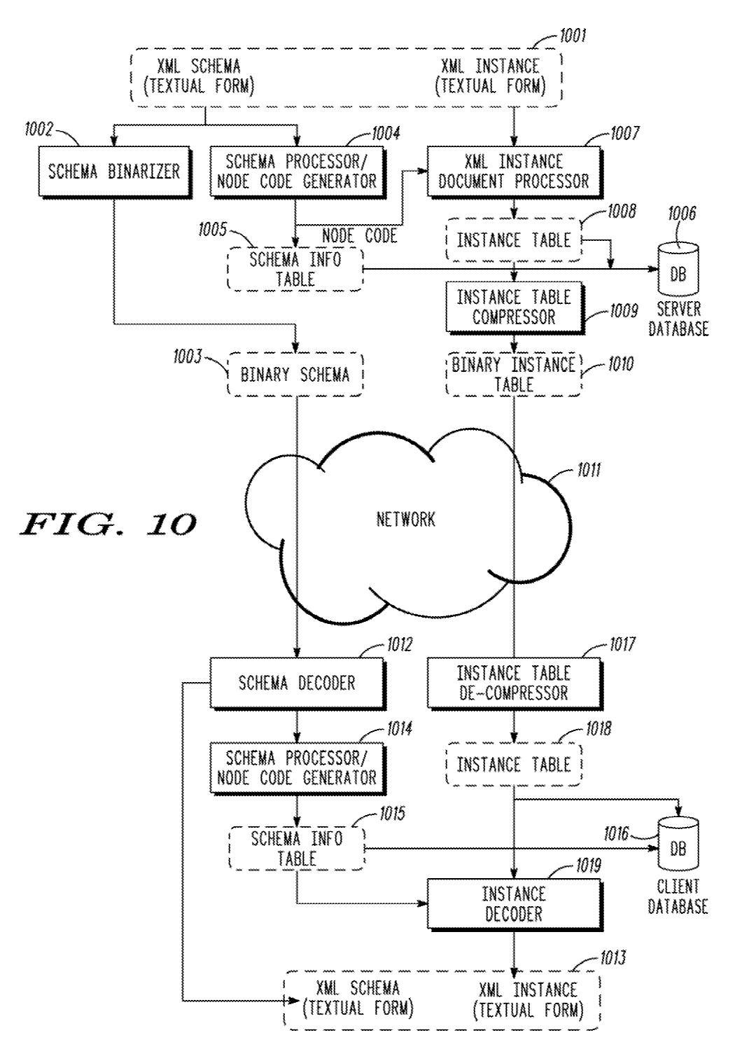

Referring now to FIG. 10, a more particular illustrative example will be described. Those skilled in the art will understand that the points of specificity expressed in this example are presented for purposes of illustration and not as points of limitation with respect to the scope or ambit of the invention itself.

In this illustrative example, a given XML document 1001 is characterized by both XML schema information as well as XML instance information. For purposes of this example, such information is presumed to assume textual form. The XML schema information is processed by a schema binarizer 1002 that effectively compresses the XML schema information and expresses the compressed result as binary schema information 1003. Such a schema binarizer 1002 may comprise, for example, the teachings set forth in a pending U.S. patent application entitled A COMPRESSED SCHEMA REPRESENTATION FOR BINARY METEADATA PROCESSING as was filed on Dec. 21, 2005 and which has been assigned application Ser. No. 11/275,276 (the contents of which are hereby incorporated herein by this reference).

The XML schema information is also processed by a schema processor and node code generator 1004 to yield corresponding node codes as correspond to that XML schema information. These node codes then serve to instantiate a corresponding schema information table 1005 that is stored, in this illustrative embodiment, in a server-side database 1006 of choice. These node codes are also provided to an XML instance document processor 1007 that also receives the aforementioned XML instance information.

This XML instance document as a function, at least in part, of the XML schema-based node codes to yield the aforementioned instance table 1008. This instance table 1008 is stored in the aforementioned database 1006 and is also provided to an instance table compressor 1009. In this illustrative embodiment the instance table compressor 1009 compresses the instance table 1008 to yield a corresponding binary instance table 1010.

In this illustrative embodiment, both the binary schema 1003 and the binary instance table 1010 are transmitted via at least one intervening network 1011 to a receiving client. This network 1011 may comprise, at least in part, a wireless network of choice. In such an application setting, the receiving client can comprise, for example, a cellular telephone, a handheld computer, or the like.

The receiving client comprises a schema decoder 1012 that recovers the XML schema information in textual form, which is then used, in part, to provide a corresponding reconstructed XML document 1013 as corresponds to the original XML document 1001. The scheme decoder 1012 also provides corresponding output to a schema processor and node code generator 1014 to thereby facilitate creation of a corresponding schema information table 1015. A client-side database 1016 can receive this schema information table 1015 for local retention.

An instance table de-compressor 1017 receives and processes the binary instance table 1010 to provide a resultant recovered instance table 1018. The aforementioned client-side database 1016 can receive this instance table 1018 if desired. In any event, an instance decoder 1019 uses both this instance table 1018 and the previously mentioned schema information table 1015 to recover the XML instance information in textual form. The latter is then used to reconstruct the XML document 1013 itself.

These teachings therefore define a unique method and apparatus that creatively and effectively reduces processing time for both the sender and receiver, and that provides substantial savings in network bandwidth upon sending XML data from sender to receiver.

Those skilled in the art will recognize that a wide variety of modifications, alterations, and combinations can be made with respect to the above described embodiments without departing from the spirit and scope of the invention, and that such modifications, alterations, and combinations are to be viewed as being within the ambit of the inventive concept.

We claim:

1. A method comprising:
providing an extensible markup language (XML) schema and XML instance data as corresponds to an XML document;
processing the XML schema apart from the XML instance data to provide resultant compressed XML schema data;
processing the XML instance data to provide a corresponding XML instance table;
compressing the XML instance table to provide a resultant compressed XML instance table.

2. The method of claim 1 wherein the XML instance table comprises at least one node code with corresponding node instance path information and node value information.

3. The method of claim 2 wherein compressing the XML instance table further comprises compressing a representation of the XML instance data.

4. The method of claim 3 wherein the at least one node code comprises a plurality of node codes wherein the plurality of node codes are differentially coded prior to being compressed.

5. The method of claim 3 wherein compressing a representation of the XML instance data comprises compressing node instance path information using a first compression technique and compressing node value information using a second compression technique with the first compression technique being different than the second compression technique.

6. The method of claim 5 wherein at least one of the first compression technique and the second compression technique is selected from a plurality of available compression techniques based at least in part on a quantity of information to be compressed.

7. The method of claim 3 further comprising transmitting the resultant compressed XML instance table.

8. The method of claim 7 further comprising transmitting an identification of corresponding XML schema information.

9. The method of claim 3 wherein compressing the XML instance table further comprises partitioning the XML instance table into groups and providing information related to the groups.

10. The method of claim 9 wherein the information related to the groups is verified by a checksum procedure.

11. The method of claim 3 further comprising using a schema information table to provide the at least one node code.

12. A method comprising:
providing an extensible markup language (XML) schema;
providing a compressed XML instance table;
decompressing the compressed XML instance table to provide a resultant XML instance table;
using the resultant XML instance table and the XML schema to facilitate a corresponding XML document process.

13. The method of claim 12 wherein decompressing the compressed XML instance table to provide a resultant XML instance table comprises separately decompressing node instance path information and node value information.

14. The method of claim 13 wherein node instance path information is decompressed using a first decompression technique and node value information is decompressed using a second decompression technique with the first decompression technique being different than the second decompression technique.

15. The method of claim 12 wherein providing an XML schema comprises receiving information corresponding to a compressed XML schema and decompressing the information.

16. The method of claim 15 wherein providing an XML schema comprises receiving an identification of XML schema information and retrieving stored XML schema information as corresponds to the identification.

17. The method of claim 16 wherein decompressing the compressed XML instance table to provide a resultant XML instance table comprises separately decompressing node instance path information and node value information.

18. The method of claim 12 wherein providing a compressed XML instance table comprises receiving a transmission of the compressed XML instance table.

19. The method of claim 18 wherein receiving a transmission of the compressed XML instance table comprises receiving a transmission of the XML instance table partitioned into groups and receiving information related to the groups.

20. The method of claim 19 wherein the information related to the groups is verified by a checksum procedure.

21. The method of claim 12 wherein decompressing the compressed XML instance table further comprises generating a schema information table.

22. An apparatus comprising:
a first memory having an extensible markup language (XML) schema as corresponds to an XML document stored therein;
a second memory having an XML instance data as corresponds to the XML document stored therein;
a binary schema processor operably coupled to the first memory and being configured and arranged to process the XML schema apart from the XML instance data to provide resultant compressed XML schema data;
an XML instance table processor operably coupled to the second memory and being configured and arranged to process the XML instance data to provide a corresponding XML instance table;
a compressor having an input operably coupled to the XML instance table processor and having a compressed XML instance table output.

23. An apparatus according to claim 22 further comprising:
a transmitter operably coupled to the compressed XML instance table output for transmitting the compressed XML instance table.

24. An apparatus according to claim 22 further comprising:
an XML schema decoder for recovering the XML schema from the compressed XML schema data; and
an XML instance table decoder for recovering XML instance data from the compressed XML instance table.

25. The apparatus according to claim 24 further comprising:
a database controller operably coupled to the XML schema decoder and the XML instance table decoder and being configured and arranged to place information from the XML schema decoder and the XML instance table decoder into a database.
